(19) United States
(12) Patent Application Publication
(10) Pub. No.: US 2007/0185633 A1
(43) Pub. Date: Aug. 9, 2007

(54) CONTROL MODULE

(75) Inventors: James D. Baal, Farmington Hills, MI (US); Daniel Vander Ley, Hudsonville, MI (US)

Correspondence Address: FOLEY AND LARDNER LLP;SUITE 500, 3000 K STREET NW, WASHINGTON, DC, 20007, US

(73) Assignee: T.K. HOLDINGS INC.

(21) Appl. No.: 11/622,909

(22) Filed: Jan. 12, 2007

Related U.S. Application Data
(60) Provisional application No. 60/758,559, filed on Jan. 13, 2006.

(51) Int. Cl. B60G 17/016

(52) U.S. Cl. 701/38; 701/45

(57) ABSTRACT

A control system for a vehicle includes a safety device controller (restraint control module) to control initiation of at least one safety device in the vehicle and a brake controller to control braking in the vehicle for roll stability control. The control system includes at least one sensor operably connected to the safety device controller. The control system also includes a single angular roll rate sensor operably connected to the safety device controller and brake controller. The single angular roll rate sensor, which includes a gyroscope, is operably connected to a precision A/D converter and is configured to detect a crash event for the safety device controller and vehicle motion for the brake controller.

### CROSS-REFERENCE TO RELATED PATENT APPLICATIONS

This application claims priority to U.S. Provisional Patent Application 60/758,559 filed Jan. 13, 2006, which is incorporated herein by reference in its entirety.

### BACKGROUND

The application relates to a control module for a vehicle that contains both crash detection and motion detection. More specifically, the application relates to a control module for both crash detection and motion detection that utilizes only one gyro.

Conventional modules include brake control modules, such as shown in U.S. Pat. Nos. 6,338,012; 6,834,218; and 6,324,446 (which are incorporated by reference in their entirety).

### SUMMARY

One exemplary embodiment relates to a control system for a vehicle. The control system comprises a safety device controller to control initiation of a safety device in the vehicle, a brake controller to control braking in the vehicle, and a single angular roll rate sensor operably connected to an A/D converter. The single angular roll rate sensor is configured to provide sufficient sensitivity for both the safety device controller and the brake controller.

Another exemplary embodiment relates vehicle sensory system. The system comprises a single angular roll rate sensor, an A/D converter connected to the angular rate sensor, and a mechanism to connect the digital signal from the A/D converter to more than one actuation system in the vehicle.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description and the accompanying exemplary embodiments shown in the drawings, which are briefly described below.

FIGS. 1(a) and 1(b) are schematic representations of a restraint control module (RCM) and a separate braking control module, in which FIG. 1(a) illustrates the RCM and FIG. 1(b) illustrates the braking control module.

FIG. 2 is a schematic representation of a combined RCM and braking control module that utilizes two separate gyros.

FIG. 3 is a schematic representation of a combined RCM and braking control module that utilizes a single gyro according to an embodiment.

FIG. 4 is a schematic representation of a vehicle illustrating the position of the RCM of FIG. 3.

### DETAILED DESCRIPTION

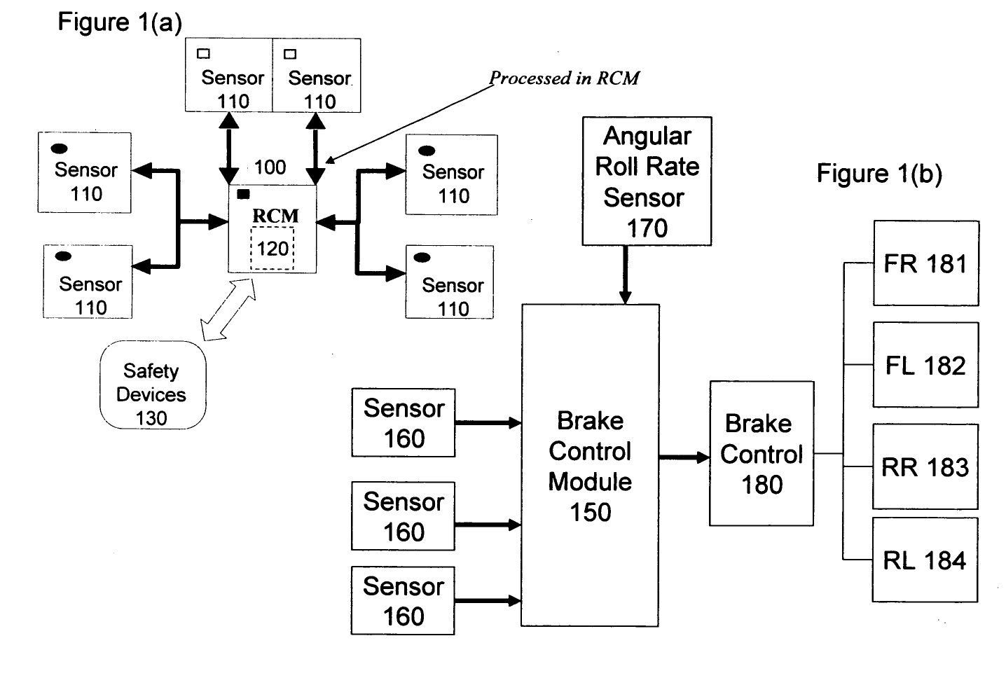

A vehicle may contain two separate control systems (or actuation systems), such as can be seen in FIG. 1: a restraint (safety) control module (RCM) 100 and a braking (roll and stability) control module 150. Each control module 100, 150 utilizes sensors 110, 160 and an angular roll rate sensor 120, 170 in order to determine what action to take. The angular roll rate sensor 120 may be, for example, a gyro. The angular roll rate sensor 120, such as a gyro, may determine the direction of a vehicle and provide an output voltage, which is proportional to the rate of turn at its sensitive axis.

The RCM 100 determines which, if any, airbags or other safety devices should deploy and sends a control signal to any required safety devices 130. The braking control module 150 determines the amount of braking pressure to apply to each tire in the case of a skid or roll over situation. The braking control module 150 determines a roll angle estimate in response to lateral acceleration, longitudinal acceleration, roll rate, and other factors, and changes the distribution of braking force to each tire in response to the roll angle estimate. The RCM 100 and braking control module 150 are operated independent of each other and do not utilize the same sensors, gyros or other equipment.

The RCM 100 utilizes a plurality of sensors 110 in various locations in a vehicle. The number, type and location of the sensors 110 may vary. For example, the sensors 110 may be accelerometers or pressure sensors, or any other suitable sensor. The sensors 110 may be located in the B-pillar, C-pillar, door, seat, and/or front portion of the vehicle. Further, an angular roll rate sensor 120, such as a gyro, is used to determine angular rate of a vehicle. The RCM 100 receives output from the sensors 110 and angular roll rate sensor 120 and may interface with various safety components 130. The RCM 100, after computing all possible data from the sensors 110 and angular roll rate sensor 120, determines which, if any, safety device should be activated. For example, the RCM 100 determines whether an airbag, pretensioner, or other safety device need by deployed or activated. The angular roll rate sensor 120 (gyro) generally has a detection range of ±240 deg/sec. The angular roll rate sensor 120 may be a part of or separate from the RCM.

The same vehicle may also utilize a braking control (roll stability) module (or controller) 150. The braking control module 150 controls a brake control 180, which in turn controls the braking of the front right brake 181, front left brake 182, rear right brake 183, and rear left brake 184. The braking control module 150 receives output from various sensors 160. For example, the sensors 160 may determine yaw rate, speed, lateral acceleration, roll rate, steering angle, longitudinal acceleration, and a pitch rate sensor. Of course, the sensors 160 described are exemplary only and any other suitable sensor may be used. Further, any suitable combination of type, amount, and location may be used. In addition, an angular roll rate sensor 170, such as a gyro, is used, which is separate from the gyro 120 in the RCM 100. The angular roll rate sensor 170 generally has a detection range of ±80 deg/sec.

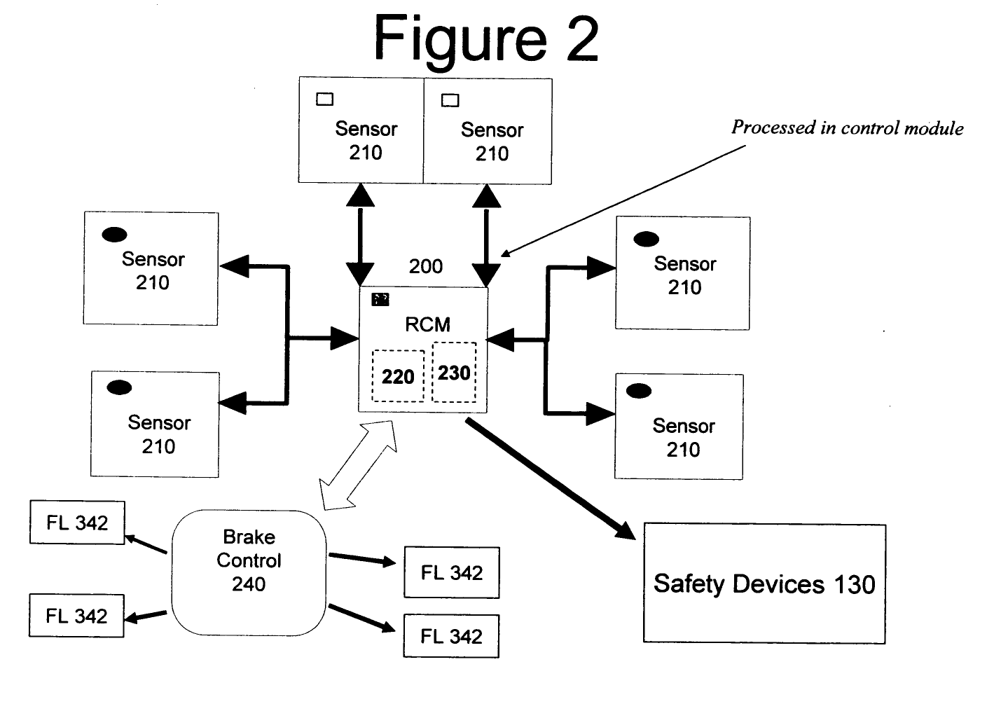

Another approach, as shown in FIG. 2, for RCM and braking control modules is to utilize a RCM 200 in which all of the sensors are incorporated into a single module 200. The vehicle uses only a single sensor cluster incorporating sensors 210. The sensors 210 send their output to the RCM 200 which sends output to the brake control 240. The RCM module 200 utilizes two separate gyros 220 and 230. One gyro 220 senses vehicle motion for the braking system and a second gyro 230 functions as a crash detector for use with the safety restraints (airbags, pretensioners, and the like). The gyro 220 for sensing motion for the braking system has a detection range of about ±80 deg/sec. The gyro 230 for the restraint control module for sensing crash detection has a detection range of about ±240 deg/sec.

The RCM 200 incorporates information from a variety of sensors 210 and, in addition, controls safety devices 130 (airbags, pretensioners, etc.) and may also control a brake control 240. The brake control 240, in turn, controls the distribution of braking force applied to the front right brake 241, front left brake 242, rear right brake 243 and rear left brake 244.

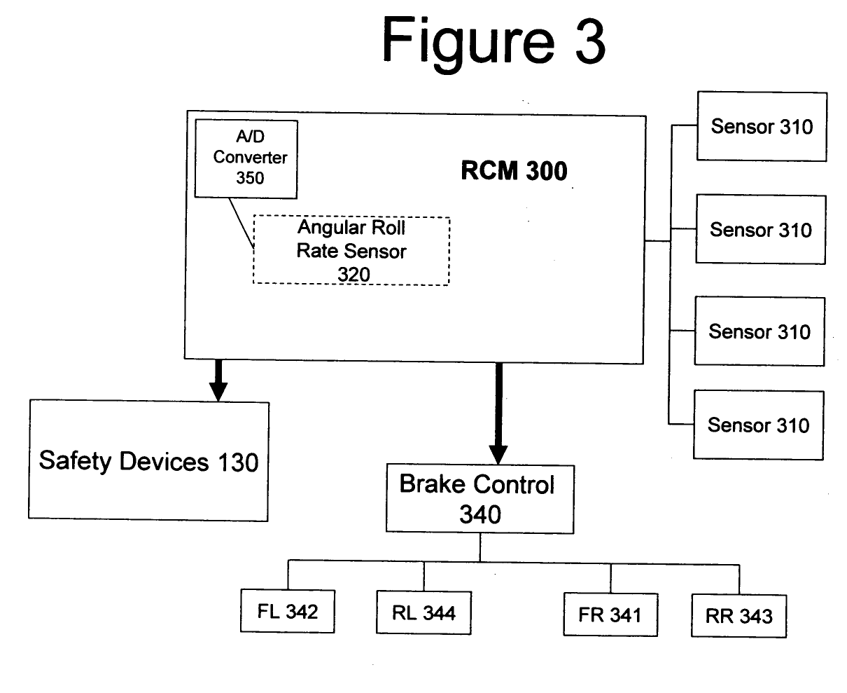

According to an embodiment, a single angular roll rate sensor 320 is utilized, such as shown in the schematic of FIG. 3. The angular roll rate sensor 320 is used in a RCM 300 and the angular roll rate sensor 320 determines roll-rate data, vehicle motion, and impending crashes. Thus, the single sensor 320 is capable of collecting data for both the restraint (safety) control and vehicle braking (roll stability) control functions. The angular roll rate sensor 320 may be part of the RCM 300 or outside the RCM 300 and the output of the angular roll rate sensor 320, along with output from a variety of other sensors 310 (such as those described above) are processed by the RCM 300. The RCM 300, in turn, sends the corresponding output to the brake control 340, which controls the distribution of braking force applied to the front right brake 341, front left brake 342, rear right brake 343 and rear left brake 344. The angular roll rate sensor 320 may be a gyro. The RCM 300 also controls the deployment of any required safety devices 130.

In order to provide the resolution required by the braking system (braking systems typically use a gyro with a detection range of ±80 deg/sec), an A/D (analog to digital) converter 350 is provided. The digital signal may be processed to provide the desired resolution such that the single gyro 320 can be used for both detection purposes; a low resolution (high range) for the necessary sensing for the RCM 300 and a high resolution (low range) for the necessary sensing for the brake control 340. The gyro 320 has a detection range of around ±240 deg/sec. The A/D converter 350 may be external or internal to the controller 300.

The gyro 320 may be a Panasonic 2^{nd} Generation sensor with an analog output, a Bosch sensor, or any other suitable sensor. The A/D converter 350 may be an 8 bit converter or a 13 bit converter. Alternatively, the A/D converter 350 may be a 14 bit or higher converter, or any other suitable type of A/D converter.

According to an embodiment, the drive or sense frequency of the gyro 320 should be significantly greater than the majority of any anticipated vibrations. When vibration in the vehicle approaches the drive or sense frequency of the gyro 320, the mechanical elements may perform frequency shifting, which may cause false data outputs. Thus, the drive or sense frequency of the gyro 320 should be high.

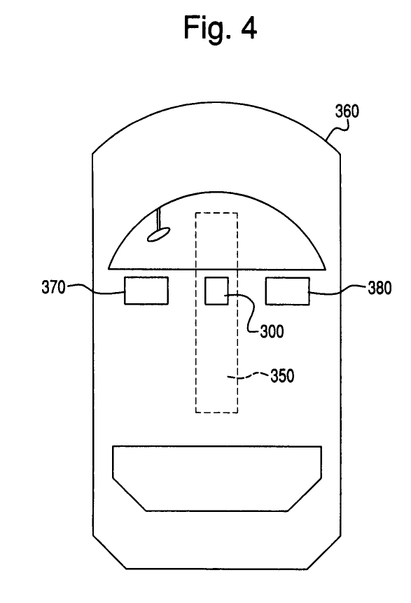

The RCM 300, such as shown in FIG. 4, may be positioned in a tunnel 350 of a vehicle 360. The tunnel 350 generally runs through the middle of a vehicle 360 in the lengthwise direction. The controller module 300 may be positioned in the tunnel 350 between the driver seat area 370 and front passenger seat area 380. It will be recognized that FIG. 3 is not drawn to scale and is shown for exemplary purposes only. Alternatively, the controller module 300 may be positioned on a B or C pillar, or any other suitable location.

On possible advantage of the embodiment is that the amount of parts required will be minimized, thus decreasing the cost to manufacture and decreasing the amount of space required for the safety/crash detection and braking/motion detection modules. For example, in the embodiment of FIG. 3, only a single gyro 320 is required. By only requiring the single gyro 320 to perform the necessary sensing operations for the RCM 300 and brake control 340 instead of two gyros, a manufacturer can save on costs for the system. For example, a manufacturer could realize substantial cost savings per control system by utilizing the single gyro 320 with the precision A/D converter 350.

It will be recognized that any type, location, and amount of sensors may be used. The types of sensors listed above (yaw rate, speed) are listed for exemplary purposes only.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

What is claimed is:

1. A control system for a vehicle, comprising:
a safety device controller to control initiation of a safety device in the vehicle;
a brake controller to control braking in the vehicle; and
a single angular roll rate sensor operably connected to an A/D converter such that the single angular roll rate sensor is configured to provide sufficient sensitivity for both the safety device controller and the brake controller.

2. The control system according to claim 1, wherein the angular roll rate sensor includes a gyro.

3. The control system according to claim 2, wherein the gyro is configured to include a detection rate of about ±240 deg/sec for detecting a crash event.

4. The control system according to claim 1, wherein the single angular roll rate sensor is configured to detect vehicle motion for the brake controller.

5. The control system according to claim 1, wherein the gyro is configured to include a detection rate of about ±80 deg/sec for detecting vehicle motion for the brake controller.

6. The control system according to claim 2, wherein the safety device controller and the brake controller together only operate with the single gyro.

7. A vehicle sensory system, comprising:
a single angular roll rate sensor;
an A/D converter connected to the angular rate sensor; and
a mechanism to connect the digital signal from the A/D converter to more than one actuation system in the vehicle.

8. The vehicle sensory system according to claim 7, wherein the angular roll rate sensor includes a gyro.

9. The vehicle sensory system according to claim 8, wherein the gyro is configured to include a detection rate of about ±240 deg/sec for detecting a crash event.

10. The vehicle sensory system according to claim 7, wherein the single angular roll rate sensor is configured to detect vehicle motion for the brake controller.

11. The vehicle sensory system according to claim 8, wherein the gyro is configured to include a detection rate of about ±80 deg/sec for detecting vehicle motion for the brake controller.
